(19) United States
(12) Patent Application Publication
(10) Pub. No.: US 2025/0113099 A1
(43) Pub. Date: Apr. 3, 2025

(54) Systems, Apparatuses, and Methods for Battery Temperature Management

(71) Applicant: Comcast Cable Communications, LLC, Philadelphia, PA (US)

(72) Inventor: Ryan Cunningham, Philadelphia, PA (US)

(21) Appl. No.: 18/479,853

(22) Filed: Oct. 3, 2023

(51) Int. Cl. H04N 23/65; H02J 7/00; H04N 7/18; H04N 7/24; H04N 17/00

(52) U.S. Cl. CPC H04N 23/65; H02J 7/0047; H04N 7/186; H04N 7/24; H04N 17/002

(57) ABSTRACT

Systems, apparatuses, and methods are described for managing the temperature of a battery of a device. It may be determined whether the temperature of the battery is outside of a predetermined operating range. The device may respond to the determination of the battery being outside of the predetermined operating range by adjusting the operating efficiency, the operating state, and/or the operating parameters of one or more of its components to bring the temperature of the battery into the predetermined range.

### BACKGROUND

Many devices, for example, video doorbell devices, operate, at least some of the time, on battery power. Additionally, many such devices operate in cold or hot environments. Operating a battery in cold or hot environments may be hazardous and/or reduce the operating life of the battery.

### SUMMARY

The following summary presents a simplified summary of certain features. The summary is not an extensive overview and is not intended to identify key or critical elements.

Systems, apparatuses, and methods are described for managing the temperature of a battery of a device (e.g., a video device). It may be hazardous and/or deleterious to a battery to apply a load to the battery when its temperature is outside of (e.g., colder or hotter than) a preferred (e.g., predetermined) range. A device may determine if the temperature of its battery satisfies a threshold. For example, the device may determine if the temperature of its battery is outside (e.g., above or below) a predetermined operating temperature range. If the device determines that the temperature of the battery satisfies the threshold (e.g., is outside of the predetermined operating range), the device may change one or more operating parameters of one or more of its components in an attempt to move the temperature of the battery to a predetermined operating temperature range. For example, the device may determine that its battery is cold (e.g., below the predetermined temperature range). Accordingly, the device may change one or more operating parameters from their normal (e.g., ideal) state to produce more heat. For example, the device may adjust one or more parameters relating to its communication interface to cause its communication interface components to work harder than during normal operation. Additionally or alternatively, the device may adjust the load on its processor to cause the processor to work harder than during normal operation. The working components may produce heat, and the battery may be heated thereby. The device may find the operating point at which the adjusted parameters are closest to normal but also produce enough heat to keep the battery in the predetermined temperature range. In some configurations, the battery may be bypassed if the temperature is outside of the predetermined range. In this regard, the life of the battery may be extended, and hazardous situations may be avoided.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example network including a video device.

FIGS. 4A-4C are a flow chart showing steps of an example method associated with managing the temperature of a battery.

FIG. 5A is an example method associated with managing the temperature of a battery.

FIG. 5B is an example method associated with managing the temperature of a battery.

FIG. 6A is an example method associated with managing the temperature of a battery.

FIG. 6B is an example method associated with managing the temperature of a battery.

FIG. 7A is an example method associated with managing the temperature of a battery.

FIG. 7B is an example method associated with managing the temperature of a battery.

FIG. 8A is an example method associated with managing the temperature of a battery.

FIG. 8B is an example method associated with managing the temperature of a battery.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

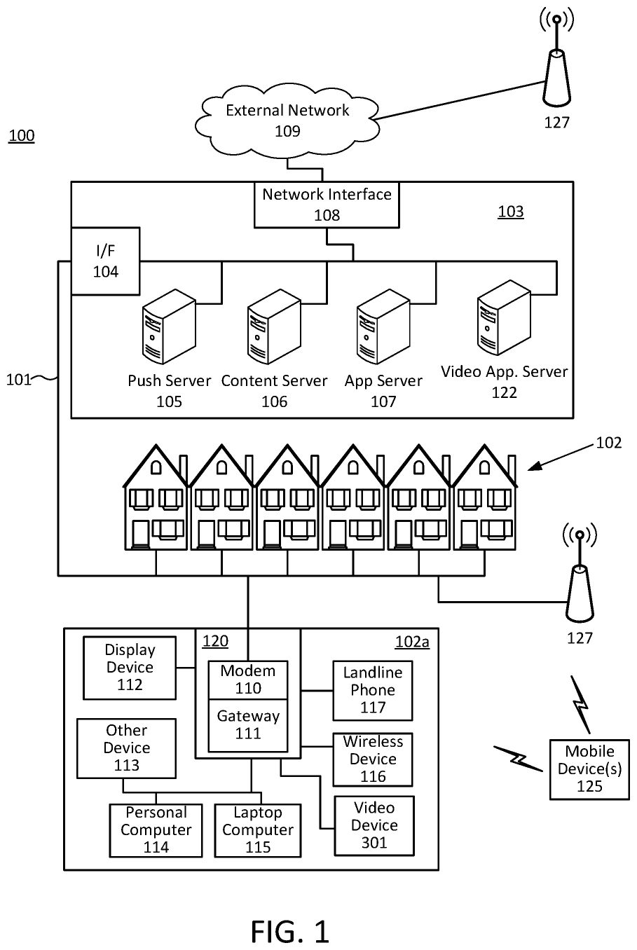

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the video application server 122 (described below), additional push, content, and/or application servers, and/or other types of servers. Although shown separately, the push server 105, the content server 106, the application server 107, the video application server 122, and/or other server(s) may be combined. Also or alternatively, one or more of the servers 105, 106, 107, 122, and/or other servers may be part of the external network 109 and may be configured to communicate (e.g., via the local office 103) with computing devices located in or otherwise associated with one or more premises 102. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol VoIP phones), video device(s) 301 (described below), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

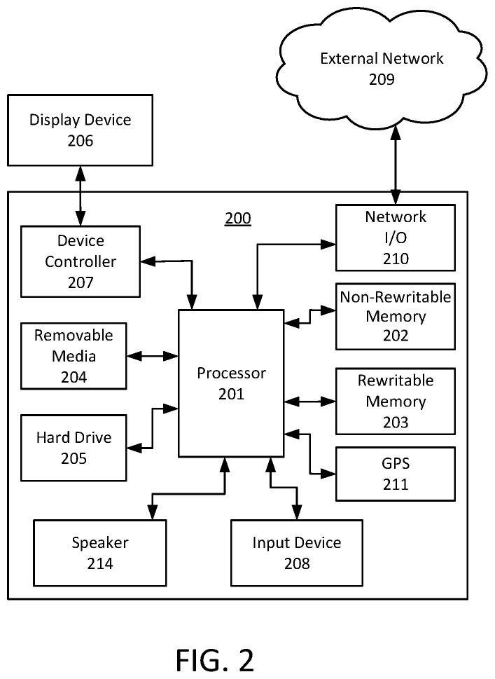

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., video device 301). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

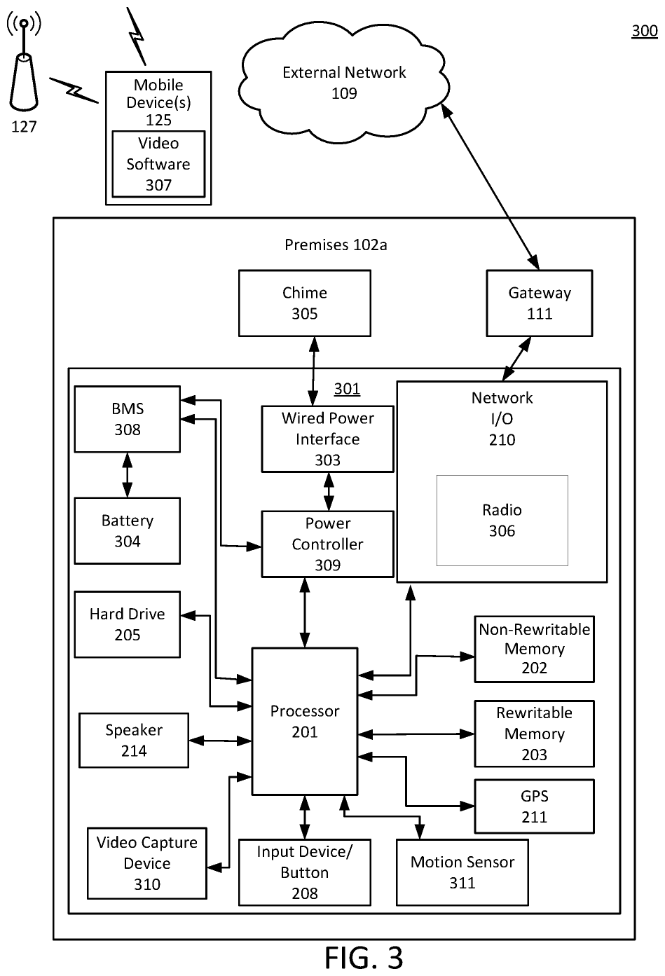

FIG. 3 shows an example network 300 including a video device 301. The example network 300 may comprise a portion of the network 100 of FIG. 1. The video device 301 may comprise, for example, a video notification device (e.g., video doorbell), a video camera, a video recording device, etc. The video device 301 may be associated with one or more of premises 102. For example, video device 301 may comprise a video doorbell of premises 102a. The video device 301 may be connected (e.g., wired and/or wirelessly) to a chime 305. For example, the chime 305 may comprise a notification device (e.g., a sound-producing device) in premises 102a. For example, the chime 305 in premises 102a may produce one or more sounds if input device 208 of the video device 301 is operated (e.g., pressed).

Additionally or alternatively, video device 301 may be connected (e.g., wired and/or wirelessly) to the external network 109 through the gateway 111. Accordingly, the video device 301 may communicate with the gateway 111 via the network I/O 210 and/or a radio 306 (e.g., a communications radio). The radio 306 may comprise, for example, one or more transceiver chips configured to facilitate communications with the video device 301 via one or more wireless communications protocols (e.g., Wi-Fi, Bluetooth, etc.). Additionally or alternatively, the video device 301 may communicate with the video application server 122. The video application server 122 may be responsible for various services relating to the video device 301. For example, the video application server 122 may receive and/or record video captured by the video device 301. Additionally or alternatively, the video application server 122 may be responsible for routing messages associated with the video device 301 between one or more additional devices. For example, the network 300 may further include mobile device 125, for example, in communication with the video device 301 via one or more of the wireless access point 127, the local office 103, and/or the external network 109. The video application server 122 may be responsible for routing messages (e.g., notifications) associated with the video device 301 to the mobile device 125 from the video device 301 and/or from the mobile device 125 to the video device 301.

Additionally or alternatively, the mobile device 125 may execute video software 307 (e.g., an application, software in a browser, etc.) associated with the video device 301. The video software 307 may provide functionality to services associated with the video device 301. For example, the video software 307 may be used (e.g., by a user) to access one or more of a substantially live video feed from the video device 301, settings associated with the video device 301, audio/video recorded from the video device 301, etc. Additionally or alternatively, the video software 307 may be used to access notifications associated with the video device 301. For example, if the input device 208 of the video device 301 is operated (e.g., pressed), the video application server 122 may receive a message comprising information indicating the operation of the input device 208. The video application server 122 may process the information and formulate a message to be sent to (e.g., pushed) the mobile device 125. The message may be accessible by a user via the video software 307. Accordingly, a notification of the operation of the input device 208 may be accessible at the mobile device 125.

The video device 301 may comprise an example of the computing device 200 and may include some or all of the components of the computing device 200. The video device 301 may include one or more additional components. For example, referring to FIG. 3, the video device 301 may comprise a power controller 309. The power controller may receive power from the wired power interface 303 and/or a battery 304. For example, if the video device is “hard-wired,” the wired power interface 303 may receive power for the video device 301 from, for example, the power of premises 102a (e.g., “low-voltage” AC power). Additionally or alternatively, the video device may be powered, at least at times, by the battery 304. The battery 304 may comprise, for example, one or more of Nickel-Cadmium (Ni—Cd), Nickel-Metal Hydride (Ni-MH), Lithium-Ion (Li-ion), Lithium Polymer (Li-Po), Lead-Acid, and/or Sodium-Ion (Na-ion) battery, and/or any other battery suitable to power the video device 301. The battery 304 may power the video device 301 some or all of the time during operation, as described in more detail below.

The video device 301 may further comprise a battery management system 308 (BMS). The BMS 308 may, for example, regulate and monitor the performance of the battery 304 to facilitate optimal power usage and prolonged battery life. The BMS 308 may facilitate charging, discharging, and power distribution and may provide real-time battery status to a user (e.g., via the video software 307). The power controller 309 may assist in controlling how the device is powered, for example, whether the video device 301 is powered via the wired power interface 303 or the battery 304.

Additionally or alternatively, the video device 301 may comprise one or more video capture device(s) 310 (e.g., a camera) and one or more motion sensors 311. In addition to that which is described elsewhere herein, the processor 201 may also or alternatively comprise an image signal processor (ISP). Accordingly, processor 201 may process and/or enhance images captured by, for example, the video capture device 310. Additionally or alternatively, the processor 201 may assist in, for example, noise reduction, color correction, white balance adjustment, and/or other image processing tasks to, for example, improve the image quality of images captured by the video device 301 (e.g., the video capture device 310).

The video device 301 (e.g., the network I/O 210 of the video device 301) may comprise a radio 306. The radio 306 may comprise a communication module that may utilize radio frequency signals to transmit and/or receive data wirelessly (e.g., from the gateway 111). The radio 306 may enable connectivity and data transfer, allowing the video device 301 to wirelessly communicate with the external network 109 (and network 100). The radio 306 may comprise a transmitter, receiver, and/or antenna.

The video device 301 may comprise an outdoor device (e.g., mounted to the exterior of premises 102a). Accordingly, the video device 301 and its components may be subject to changing and sometimes harsh, extreme, and/or non-ideal environments. For example, depending on the location of premises 102a, the video device 301 may be subject to cold and/or hot temperatures for periods of time. However, such nonideal conditions (e.g., temperatures) may damage the battery 304, especially if the battery 304 is used to power the video device 301 in such conditions. The life of the battery 304 may be reduced if forced to operate in cold and/or hot conditions. Additionally or alternatively, operating the battery 304 in such conditions may be hazardous. Additionally or alternatively, operating the battery 304 in such conditions may cause the battery to operate with reduced efficiency. For example, operating the battery 304 in such conditions may cause the battery to lose charge sooner than it would if similarly operated in preferred conditions. Accordingly, there may be a predetermined range of temperatures in which it is preferred to operate the battery 304 (e.g., a preferred range of temperatures).

As described above, the video device 301 may be “hard-wired” and/or powered by the battery 304. Additionally, the video device 301 may be connected to the chime 305. In many traditional hard-wired doorbell systems (e.g., video doorbell systems), if the doorbell button is operated, the hard-wired power to the doorbell is shorted, causing the connected chime to sound. In a configuration in which the video device 301 is hard-wired, if the input device 208 is operated, the hard-wired power may be shorted in order to cause the chime 305 to sound (e.g., to power the chime). In such a system, the battery 304 may be used to operate the video device 301 during such a short. If the battery 304 is operated at nonideal temperatures as described above, the battery 304 may be adversely affected. In other systems, the video device 301 may not be hard-wired but may be powered by the battery 304 only. Here too, if the battery 304 is used at nonideal temperatures, the battery 304 may be adversely affected. More load placed on a battery at nonideal temperatures may cause more adverse effects.

Accordingly, it may be advantageous to operate the battery 304 in a predetermined temperature range. The present disclosure relates to apparatuses, systems, and methods for managing the temperature of the battery 304 by altering the temperature of the battery 304. For example, as described in more detail below, a measured temperature of the battery 304 may be used to make video device 301 operating decisions. Such decisions may be made, for example, to control the load on the battery 304 and/or to increase and/or decrease the temperature of the battery 304. For example, if the video device 301 detects that the temperature of the battery 304 is outside of a predetermined range, the video device 301 may alter its operation (e.g., change one or more operating efficiencies) to change the temperature of the battery 304.

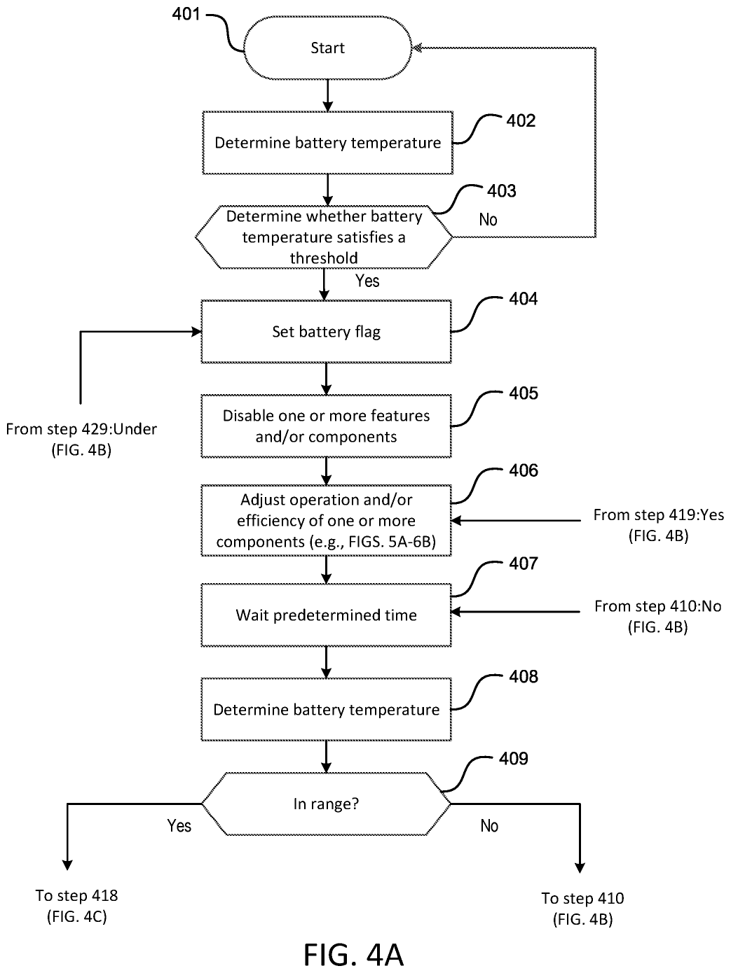

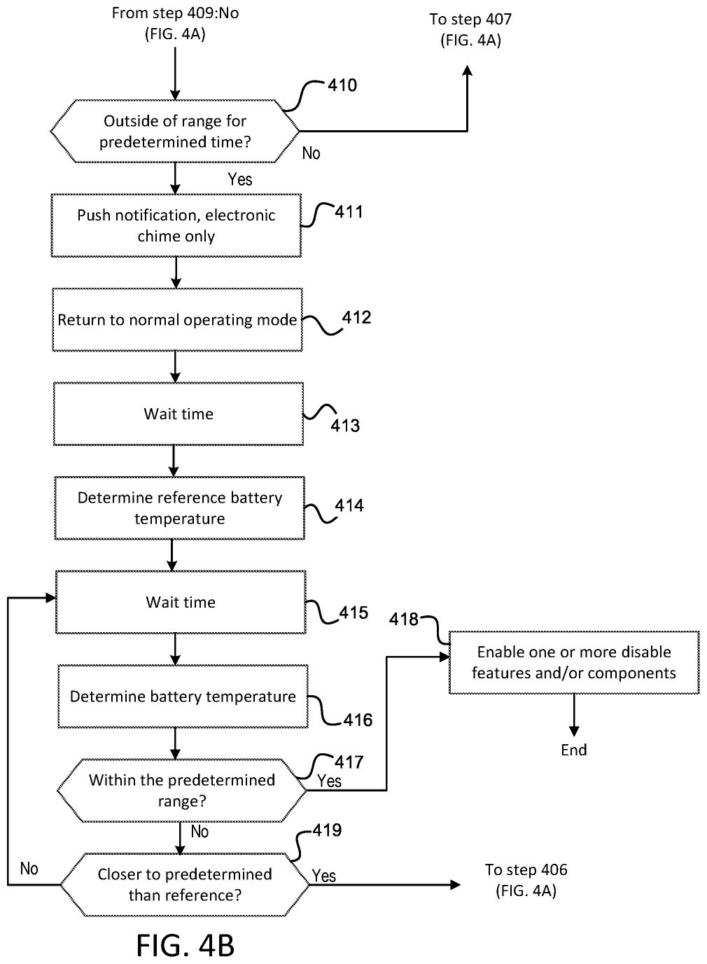

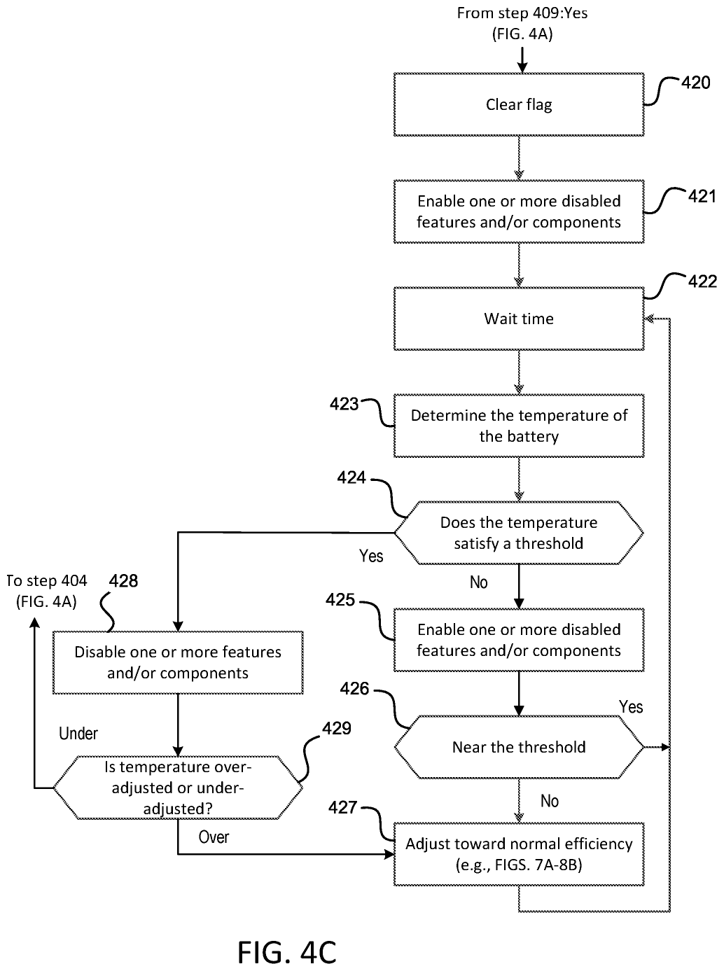

The video device 301 may comprise different operating modes for different geographic regions. Video devices 301 having different configurations may be distributed to different geographic regions. Alternatively, the video device 301 may configure itself, for example, upon installation and/or boot-up, based on the geographic region in which it is installed. The video device may use, for example, its GPS microprocessor 211 to determine its geographic region and download and/or run configurations based on the GPS microprocessor 211 data. Additionally or alternatively, the video device may use IP addresses (e.g., the IP address of the connected gateway 111 and/or an IP address assigned to the video device 301) to assist in determining the geographic region of the video device 301. Accordingly, some of the features described below with respect to FIGS. 4A-8B may be configured differently for different regions.

FIGS. 4A-4C are a flow chart showing steps of an example method associated with managing the temperature of a battery (e.g., battery 304). One, some, or all steps of the example method of FIGS. 4A-4C may be performed by a video device (e.g., video device 301) and/or one or more components thereof. Accordingly, the example method of FIGS. 4A-4C are described below using the example of performance by the video device 301. Also or alternatively, one, some, or all steps of the example method of FIGS. 4A-4C may be performed by one or more other computing devices (e.g., the mobile device 125, the video application server 122, etc.). Steps of the example method of FIGS. 4A-4C may be omitted, performed in other orders, and/or otherwise modified, and/or one or more additional steps may be added.

The example method of FIGS. 4A-4C starts at step 401, and at step 402, the video device 301 may determine (e.g., measure, detect, record) the temperature of the battery 304. Additionally or alternatively, the video device 301 may access local weather reports (e.g., utilizing GPS microprocessor 211) and may only operate the example method of FIGS. 4A-4C in predefined weather conditions (e.g., if the temperature of the battery 304 is expected to be outside of a predetermined operating range). At step 403, the video device 301 may determine whether the temperature of the battery satisfies a threshold. For example, the video device 301 may determine whether the temperature of the battery 304 is within a predetermined range. This determination may comprise comparing the temperature determined in step 402 with stored (e.g., in a table) predetermined operating temperature values and/or ranges. If the temperature of the battery 304 does not satisfy the threshold (e.g., is within a predetermined range) (e.g., 403: No), the video device may perform step 401. Additionally or alternatively, the video device 301 may wait a predefined time (e.g., a half hour, a day, two days, etc.) before performing step 402 again. If, at step 403, it is determined that the temperature of the battery 304 satisfies the threshold (e.g., is outside, e.g., below or above) a predetermined temperature range (e.g., 403: Yes), the video device 301 may perform step 404.

At step 404, the video device 301 may set a battery flag (e.g., an indication). The battery flag may indicate (e.g., to other processes) that the temperature of the battery 304 is presently outside of the predetermined operating temperature range. In step 405, the video device 301 may disable one or more of its associated features and/or components. For example, in an example configuration where the video device 301 is hard-wired, the video device 301 may disable the chime 305 in step 405. Accordingly, in some such example configurations, the hard-wired video device 301 may no longer short its hard-wired power (e.g., as controlled by power controller 309, BMS 308, and or processor 201) and may no longer be powered by the battery 304. In such a configuration, disabling the chime 305 may effectively forgo the use of the battery 304. In battery-only powered configurations, the video device 301 may disable one or more features and/or functions (e.g., nonessential features and/or functions) to reduce the load on the battery 304.

At step 406, the operation of one or more components of the video device 301 may be adjusted (e.g., altered, modified, etc.). For example, the operating efficiency, the operating state, and/or operating parameters of one or more communications components (e.g., wireless communications components) of the video device 301 may be adjusted. Adjusting the operating efficiency of one or more components of the vide device may comprise, for example, adjusting the ratio of work performed by the one or more components of the video device to the energy expended and/or consumed by the one or more components of the video device. For example, at step 406, the video device 301 may determine a link budget for the connection (e.g., a wireless connection and/or channel) between the video device 301 (e.g., the radio 306 and/or network I/O 210) and the gateway 111. The link budget may comprise an analysis of the connection between the video device 301 and the gateway 111. For example, the link budget may analyze the total gain and loss in the connection. The link budget may, additionally or alternatively, account for one or more of the power required to transmit signals, the path loss of the signal, for example, due to the distance between the video device 301 and the gateway, the gain, any potential cable loss, fade margin (e.g., a safety margin considering the signal environment), and other parameters associated with communications and/or the connection between the video device 301 and the gateway 111.

Additionally or alternatively, in step 406, a channel capacity for the communications channel between the video device 301 and the gateway 111 may be determined. The channel capacity may comprise the maximum (or substantially the maximum) data transfer rate and/or information capacity that may be reliably transmitted over the connection (e.g., the channel). The channel capacity may be influenced by one or more of, for example, the available channel bandwidth, the Signal-to-Noise-Ratio (SNR), the Modulation Coding Scheme (MCS) level used to encode/decode communicated data, and/or the channel condition. The MCS level may comprise a combination of modulation and error correction coding used in wireless communications. The MCS level may be associated with an MCS index. The MCS level may be used to determine how data is transferred and may affect the performance of the connection. Different MCS levels may correspond to different data rates. The video device 301 may select an MCS level based on desired signal quality and one or more of the above-mentioned communication parameters. The selection of an MCS level may affect video device 301 performance.

For example, the MCS level selected may affect the amount of free air time (FAT) used by the video device 301 (e.g., by the radio 306 of the video device 301). For example, a higher MCS level may correspond to a higher data transfer rate. With a higher data transfer rate (e.g., more data per time), the FAT used to transfer the data may be reduced. Whereas if a lower MCS level is selected, the data rate may decrease. Accordingly, with a lower MCS level, more FAT may be used to transfer the same amount of data. The more FAT used by the radio 306, the more the radio 306 will remain on (e.g., on time), and vice versa. Accordingly, the amount of FAT used may be proportional to the work of the radio 306. Therefore, reducing the MCS level used may reduce the efficiency of one or more communications components of the video device (e.g., the radio 306)

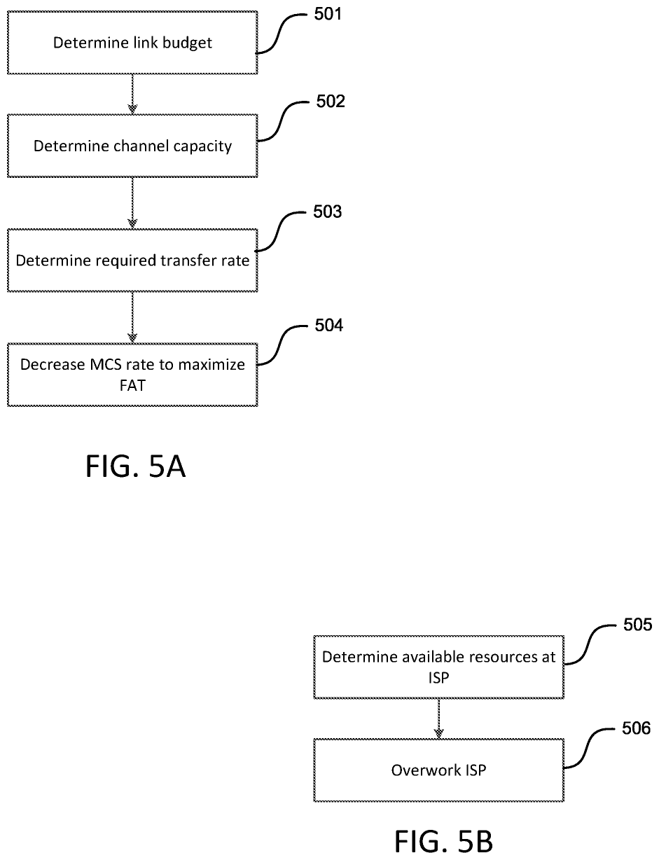

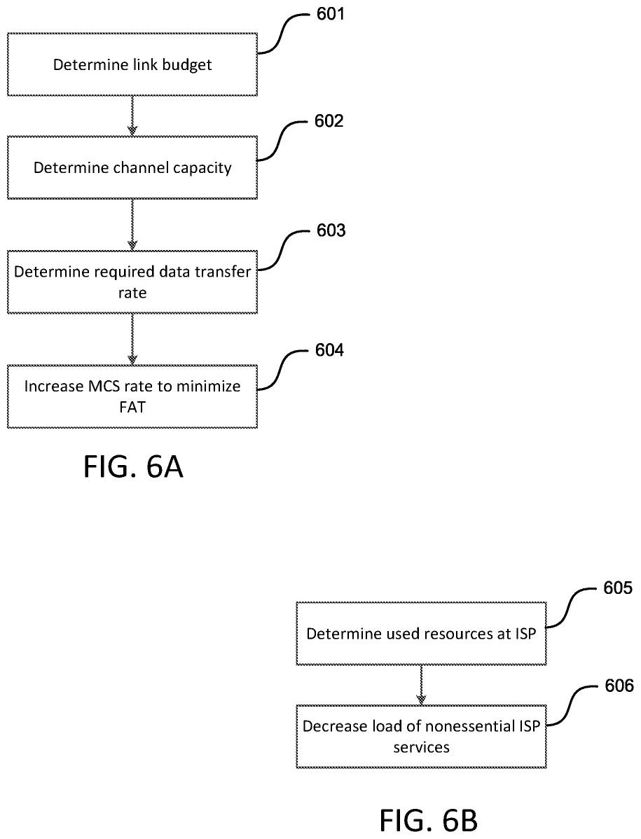

Thus, if the temperature of the battery 304 is below a desired operating temperature (e.g., is cold), the video device 301 (e.g., in step 406) may select an MCS level that is lower than the MCS level used during normal (e.g., ideal) operation. Selecting a lower MCS level may increase the FAT used and may cause the radio 306 to remain on for longer periods of time. The working radio 306 may create heat. In turn, the created heat may be directed (e.g., via conduction, convection, and/or radiation) to warm the battery 304. In such a manner, the operating efficiency of the video device 301 (e.g., the radio 306) may be reduced in order to heat the battery 304. In some example configurations, the adjustments in operation in step 406 may be maximum adjustments (e.g., as described below with reference to FIGS. 5A-5B and FIGS. 6A-6B).

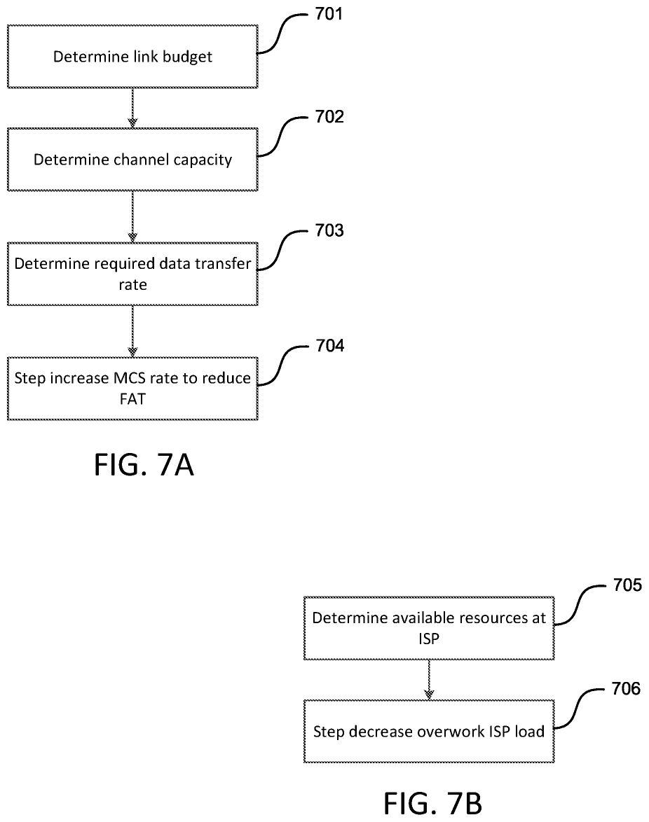

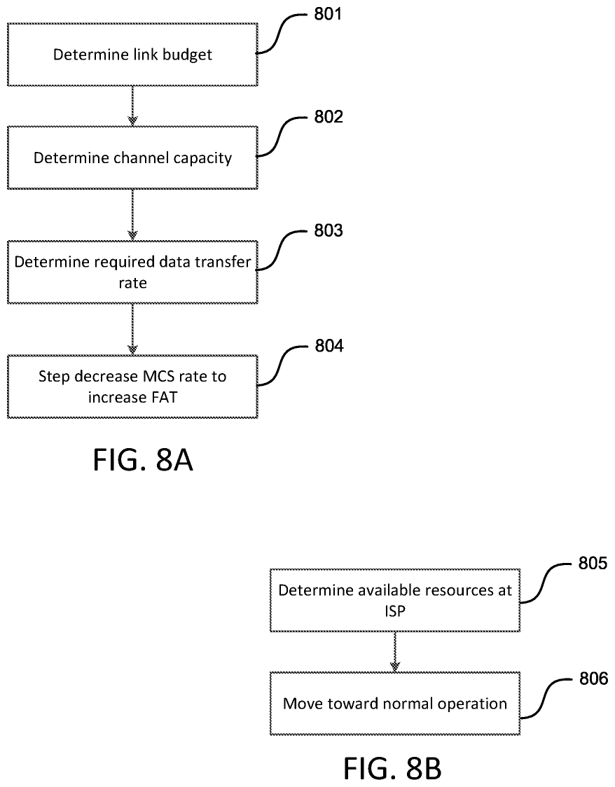

One or more additional steps may be performed to adjust the operation (e.g., the operating efficiency) of the one or more components of the video device, for example, as described with reference to FIGS. 5A-8B. In examples where, at steps 402 and 403, it is determined that the temperature of the battery satisfies a threshold and is below the predetermined operating temperature range (e.g., the battery is cold), the efficiency and/or operating parameters of one or more components of the video device may be adjusted to increase the temperature of the battery 304, for example, as described with reference to FIGS. 5A-5B, and FIGS. 7A-7B. In examples where, at steps 402 and 403, it is determined that the temperature of the battery 304 satisfies a threshold and is above the predetermined operating temperature range (e.g., the battery 304 is hot), the efficiency and/or operating parameters of one or more components of the video device may be adjusted to reduce the temperature of the battery 304, for example, as described with reference to FIGS. 6A-6B, and FIGS. 8A-8B.

At step 407, the video device may wait a predetermined amount of time (e.g., 30 minutes, 45 minutes, an hour, etc.) while operating the video device, as adjusted in step 406. After the predetermined amount of time, the video device 301 may perform step 408. At step 408, the video device may determine (e.g., measure, detect, record) the temperature of the battery 304 and proceed to step 409.

At step 409, the video device may determine whether the temperature of the battery 304 (e.g., the temperature determined in step 408) is within the predetermined range. If the temperature of the battery 304 is outside of the predetermined range (e.g., 409: No), the video device 301 may perform step 410 (FIG. 4B). Referring to FIG. 4B, at step 410, the video device may determine whether the temperature of the battery 304 has been outside of the predetermined range for a predetermined period of time (e.g., 12 hours, 24 hours, 2 days, etc.). For example, at step 410, the video device may determine if the temperature is outside of the predetermined range for a predetermined amount of time after being adjusted at step 406. If the temperature of the battery 304 has not been outside of the predetermined range for the predetermined period of time (e.g., the predetermined period of time of step 410) (e.g., 410: No), the video device 301 may perform step 407 (FIG. 4A) (e.g., continue to operate as adjusted in step 406). If, at step 410, it is determined that the temperature of the battery 304 has been outside of the predetermined range for the predetermined period of time (e.g., 410: Yes), the video device 301 may perform step 411.

In step 411, the video device 301 may retain and/or set the disability of the chime 305. Additionally or alternatively, the video device 301 may cause a message and/or indication to be sent to the video software 307 (e.g., executing on mobile device 125), for example, via the video application server 122, notifying the user that the chime 305 remains disabled and/or is presently disabled. With the chime disabled, a speaker (e.g., speaker 214) may be used to create an aural notification instead of the chime.

At step 412, the video device 301 may return to normal operation. For example, the efficiency and/or parameter operating adjustments made in step 406 may be undone, and the video device 301 may operate as prior to the adjustments of step 406 and/or without consideration for the adjustments made in step 406 (e.g., normally). The efficiency adjustments may be undone at step 412 because it may be determined that the adjustments made, for example, in step 406 (FIG. 4A), are unable to cause move the temperature of the battery 304 into the predetermined range. At step 413, the video device 301 may wait a predetermined period of time (e.g., 2 hours, 3 hours, 12 hours, etc.) and perform step 414. At step 414, the video device 301 may determine (e.g., measure, detect, record) the temperature of the battery 304. The temperature of the battery 304 determined in step 414 may be used as a reference temperature (as described below) for determining a temperature of the battery 304 that could not be corrected (e.g., moved into the predetermined range) with the adjustments of step 406).

At step 415, the video device 301 may wait a predetermined amount of time (e.g., 12 hours, 1 day, 2 days) and perform step 416. At step 416, the video device 301 may determine (e.g., measure, detect, record) the temperature of the battery 304. Additionally or alternatively, as described above, the video device 301 may retrieve information from local weather reports to make decisions on the amount of time to wait at step 415 and/or whether to perform step 416. At step 417, the video device 301 may determine whether the temperature of the battery 304 is within the predetermined temperature range. If at step 417 the video device 301 determines that the temperature of the battery 304 is within the predetermined temperature range (417: Yes), the video device 301 may, at step 418, enable one or more disabled features and/or components (e.g., enable the one or more features and/or components disabled at step 405 (FIG. 4A) and the example method of FIGS. 4A-4C may end. If at step 417, the video device 301 determines that the temperature of the battery 304 is not within the predetermined range (417: No), the video device 301 may perform step 419.

At step 419, the video device 301 may determine whether the temperature determined at step 416 is closer to the predetermined range than the temperature determined in step 414. The determination of whether the temperature determined in step 416 is closer to the predetermined temperature than the temperature measured in step 414 may comprise a determination that the temperature is closer to the predetermined temperature by, for example, a percentage or a specific amount.

If at step 419, it is determined that the temperature of the battery 304 is not closer (e.g., by a predetermined amount) to the predetermined temperature range than the temperature determined in step 414 (e.g., 419: No), the video device 301 may perform step 415 to wait the predetermined period of time. If at step 419, it is determined that the temperature of the battery 304 is closer (e.g., by a predetermined amount) to the predetermined temperature range than the temperature determined in step 414 (e.g., 419: Yes), The video device 301 may, at step 420 determine whether the temperature of the battery 304 is still outside the pre but is still outside of the predetermined temperature range, the video device 301 may perform step 406 (FIG. 4A), and the operation (e.g., the operating efficiency, the operating state, and/or operating parameters) of one or more components of the video device 301 may be adjusted (e.g., altered, modified, etc.).

Referring back to FIG. 4A and step 409, if at step 409 it is determined that the temperature (e.g., determined at step 408) is within the predetermined range (e.g., 409: Yes), the video device 301 may perform step 420 (FIG. 4C). Referring to FIG. 4C, at step 420, the flag and/or indicator (e.g., set in step 404) may be cleared. In step 421, the features and or components (e.g., the chime) that were disabled (e.g., in step 405) may be enabled. At step 422, the video device 301 may wait a predetermined period of time (e.g., 30 minutes, 45 minutes, 1 hour, etc.) and may perform step 423.

At step 423, the video device 301 may determine the temperature of the battery 304 and perform step 424. At step 424, the video device 301 may determine whether or not the temperature of the battery 304 satisfies a threshold. For example, a determination that the battery 304 satisfies a threshold in step 424 may comprise a determination that the temperature of the battery 304 is outside of the predetermined range. If the temperature does not satisfy the threshold (e.g., the temperature is within the predetermined range) (e.g., 424: No), the video device 301 may perform step 425. In some example configurations, the threshold of step 424 may comprise the same threshold as step 403. At step 425, one or more features and/or components of the video device 301 may be enabled (e.g., features and/or components disabled at step 428), and the video device 301 may perform step 426.

At step 426, the video device 301 may determine whether the temperature of the battery 304 (e.g., determined in step 423) is near (e.g., proximate to) the threshold (e.g., the threshold of step 424). Determining whether the temperature of the battery 304 is near the threshold may comprise determining whether the temperature of the battery 304 is near a close boundary of the predetermined temperature range. For example, the predetermined temperature range may comprise a lower boundary and an upper boundary. If the temperature determined in step 408 is below the predetermined range (e.g., the battery 304 is cold and the video device 301 is attempting to heat the battery 304), a temperature near the close boundary (e.g., near the threshold) in step 426 may comprise a temperature that is within the predetermined range but near the lower boundary for the predetermined temperature range. Alternatively, if the temperature determined in step 408 is above the predetermined range (e.g., the battery 304 is hot), a temperature near the close boundary (e.g., near the threshold) may comprise a temperature within the predetermined range and near the upper boundary for the predetermined range.

If, at step 426, it is determined that the temperature (e.g., determined in step 423) is not near the threshold) (e.g., 426: No), the video device 301 may perform step 427. At step 427, the operating efficiency, the operating state, and/or operating parameters of the one or more components of the video device 301 that were adjusted in step 406 may be adjusted (e.g., altered, modified, etc.) toward normal (e.g., ideal) operating conditions. For example, assume that prior to the start of the example method of FIGS. 4A-4C, the video device 301 was using an MCS level corresponding to an MCS index of 11 (e.g., on the Institute of Electrical and Electronics Engineers (IEEE) 802.11AX Modulation and Coding Schemes published by the IEEE). Then assume that, at step 406, the video device 301 changed the MCS index to 2 (e.g., thereby increasing the amount of used free air time). Then, at step 427, the MCS index may be adjusted toward normal efficiency (e.g., MCS index 11) but may not be adjusted entirely toward normal efficiency. Continuing the above example, at step 427, the video device 301 may select an MCS index of 4 (e.g., adjusted toward normal efficiency). In this way, a balance may be reached between video device 301 efficiency and battery 304 temperature. Step 427 may be described in further detail in FIGS. 7A-7B and FIGS. 8A-8B. After step 427, the method may return to step 422 and wait a predetermined period of time.

Returning to step 424, if at step 424 it is determined that the temperature of the battery 304 satisfies the threshold, (e.g., the temperature is not within the predetermined range) (e.g., 424: Yes), the video device 301 may perform step 428. At step 428, one or more features and/or components of the video device 301 and/or associated with the video device 301 (e.g., chime 305) may be disabled. Step 428 may substantially correspond to step 405 of FIG. 4A. At step 429, it may be determined whether the temperature of the battery 304 was over-corrected or under-corrected. For example, assume at step 403 it is determined that the temperature of the battery 304 satisfies a threshold and is below the predetermined range (e.g., the battery 304 is cold). Accordingly, the operation of one or more components may be adjusted, for example, as described in step 406 and/or step 427. If, following the cold battery example, the temperature of the battery 304 at step 429 is below the predetermined range, the temperature of the battery 304 may be considered under-corrected. If, however, following the same cold battery example, the temperature of the battery 304 at step 429 is above the predetermined range, the temperature of the battery 304 may be considered over-corrected. If the temperature of the battery 304 was over-corrected (e.g., 429: Over), the video device 301 may perform step 427, and one or more components of the video device 301 (e.g., the one or more components adjusted in step 406) may be adjusted (e.g., altered, modified, etc.) toward normal operating efficiency, operating state, and/or operating parameters. Additionally or alternatively, if the temperature of the battery 304 was over-corrected (e.g., 429: Over), the example method may end. If the temperature of the battery 304 was under-corrected (e.g., 429: Under), the video device 301 may perform step 404 (FIG. 4A).

FIGS. 5A and 5B are flow charts showing steps of example methods associated with managing the temperature of a battery (e.g., battery 304). For example, one, some, or all steps of FIGS. 5A and/or 5B may be performed for a battery in a cold environment. Additionally, one, some, or all steps of FIGS. 5A and/or 5B may be performed by the video device 301 to increase and/or cause an increase in the temperature of the battery 304. One, some, or all steps of the example methods of FIGS. 5A and 5B may be performed by a video device (e.g., video device 301) and/or one or more components thereof. Accordingly, the example method of FIGS. 5A and 5B are described below using the example of performance by the video device 301. Also or alternatively, one, some, or all steps of the example methods of FIGS. 5A and 5B may be performed by one or more other computing devices (e.g., the mobile device 125, the video application server 122, etc.). Steps of the example methods of FIGS. 5A and 5B may be omitted, performed in other orders, and/or otherwise modified, and/or one or more additional steps may be added. The example methods of FIGS. 5A and 5B may be used to heat a cold battery and/or maintain the temperature of a battery in a cold environment. The example methods of FIGS. 5A and 5B may each comprise examples, or together, an example of step 406 of FIG. 4A.

Referring to FIG. 5A, at step 501, the video device 301 and/or one or more components thereof may determine a link budget for a communications link. For example, video device 301 may determine a link budget for the communications link between the video device 301 and the gateway 111. An example link budget is described in more detail above with respect to step 406 of FIG. 4A.

At step 502, the video device 301 and/or one or more components thereof may determine a channel capacity of a communications channel associated with the video device 301. For example, the video device 301 may determine a channel capacity of a communications channel between the video device 301 and the gateway 111. Channel capacity is described above with respect to step 406 of FIG. 4A. Additionally, the channel capacity may comprise the maximum data transfer rate and/or information capacity that may be reliably transmitted over a wireless channel. Channel capacity may comprise the upper limit of how much data can be transmitted without (and/or with minimal) errors and/or degradation. As described above, channel capacity may be influenced by one or more of the bandwidth, SNR, MCS, channel conditions, and/or other conditions.

At step 503, the video device 301 and/or one or more components thereof may determine the required data transfer rate for the present communications over the channel. The required data transfer rate may be, for example, less than or equal to channel capacity. For example, assuming that at step 502, in determining channel capacity, it is determined that the video device 301 can achieve gigabit speeds over its wireless channel. However, at step 503, it is determined that, for its current communications, the video device 301 only requires speeds of two megabits per second. Accordingly, in such an example, the required data transfer rate may be less than the channel capacity.

At step 504, the video device 301, and/or one or more components thereof, may decrease the MCS level to increase the amount of used FAT. Decreasing the MCS level to increase the amount of used FAT may reduce the efficiency of one or more components of the video device 301. MCS is additionally described above with respect to FIGS. 4A-4C. As described, the MCS level used may also affect the data transfer rate. At step 504, the video device 301 may use (e.g., reduce) an MCS level to substantially cause the required data transfer rate (e.g., determined in step 503) rather than use an MCS level to cause the channel capacity transfer rate. Accordingly, the amount of used FAT may be increased, and the communication radios (e.g., radio 306 of video device 301) may remain on for longer periods of time (e.g., increased on time), thereby generating more heat. The heat produced may be directed (e.g., via conduction, convection, and/or radiation) to the battery 304, for example, to heat up a cold battery in an attempt to reach and/or maintain a predetermined battery operating temperature. At step 504, the MCS may be substantially maximally reduced to substantially maximize the used FAT, based on the required data transfer rate.

Referring to FIG. 5B, other processes and components may also or alternatively be used to heat a cold battery and/or maintain a predetermined battery temperature in a cold environment. For example, the operation and/or operating efficiency of one or more processors (e.g., processors 201) may be adjusted. Adjusting the operating efficiency of the one or more processors may comprise causing the one or more processors to perform operations in excess of operations necessary for carrying out functions, of the video device 301, other than temperature control functions. At step 505, a video device 301 may determine the available resources at the processor 201. At step 506, the video device 301 may increase the processing load on its processor. Increasing the processing load on the processor may comprise artificially increasing the processor load. For example, the video device 301 may store one or more programs and/or loops (e.g., FOR loops). The video device 301 may cause the processor to process one or more of the programs and/or loops to overwork the processor. For example, overworking the processors may comprise increasing (e.g., artificially) the computational load on the processor for the purpose of increasing the work of the processor and/or causing the processor to perform computations and/or work that may not be needed to support other functions of the device. As a result, the processor may produce more heat, and the produced heat may be channeled and/or directed (e.g., via conduction, convection, and/or radiation) to the battery 304.

FIGS. 6A and 6B are flow charts showing steps of example methods associated with managing the temperature of a battery (e.g., battery 304). For example, one, some, or all steps of FIGS. 6A and/or 6B may be performed for a battery in a hot environment. Additionally, one, some, or all steps of FIGS. 6A and/or 6B may be performed by the video device 301 to decrease and/or cause a decrease in the temperature of the battery 304. One, some, or all steps of the example methods of FIGS. 6A and 6B may be performed by a video device (e.g., video device 301) and/or one or more components thereof. Accordingly, the example method of FIGS. 6A and 6B are described below using the example of performance by the video device 301. Also or alternatively, one, some, or all steps of the example methods of FIGS. 6A and 6B may be performed by one or more other computing devices (e.g., the mobile device 125, the video application server 122, etc.). Steps of the example methods of FIGS. 6A and 6B may be omitted, performed in other orders, and/or otherwise modified, and/or one or more additional steps may be added. The example methods of FIGS. 6A and 6B may be used to reduce the heat of a hot battery and/or maintain the temperature of a battery in a hot environment. The example methods of FIGS. 6A and 6B may each comprise examples, or together, an example of step 406 of FIG. 4A.

Referring to FIG. 6A, at step 601, the video device 301 and/or one or more components thereof may determine a link budget for a communications link between the video device 301 and another device (e.g., a gateway). For example, video device 301 may determine a link budget for the communications link between the video device 301 and the gateway 111. An example link budget is described in more detail above with respect to step 406 of FIG. 4A.

At step 602, the video device 301, and/or one or more components thereof, may determine a channel capacity of a communication channel associated with the video device 301. For example, the video device 301 may determine a channel capacity of a communication channel between the video device 301 and the gateway 111. Channel capacity is described above with respect to step 406 of FIG. 4A and step 502 of FIG. 5A. At step 603, the video device 301, and/or one or more components thereof, may determine the required data transfer rate for the present communications over the channel. At step 604, the video device 301, and/or one or more components thereof, may increase the MCS level to decrease the amount of used FAT. MCS is described above with respect to FIGS. 4A-4C. For example, the video device 301 may increase the MCS level above what would be acceptable under normal operating conditions. For example, the video device 301 may increase the MCS to a level that may have a higher chance of introducing transmission errors and/or degradation. Increasing the MCS level as such may decrease the amount of used FAT, thereby reducing the operating time of the radio 306. In this regard, the video device 301 and/or components thereof may produce less heat than during normal operation. Thus, less heat may be transferred to the battery 304 than during normal operation.

Other processes may also or alternatively be used to reduce the heat of a battery and/or maintain a predetermined battery temperature in a hot environment. Referring to FIG. 6B, at step 606, a video device 301 may determine the used resources at the processor 201. At step 606, the video device 301 may terminate and/or reduce certain processes that would otherwise run. For example, the processor may determine any non-essential processes. The processor may terminate one or more of the non-essential processes. Thereby, the processor may work less and produce less heat, and less heat may be transferred to the battery 304 than during normal operation.

FIGS. 7A and 7B are flow charts showing steps of example methods associated with managing the temperature of a battery (e.g., battery 304). For example, one, some, or all steps of FIGS. 7A and/or 7B may be performed for a battery in a cold environment. Additionally, one, some, or all steps of FIGS. 7A and/or 7B may cause a decrease in the temperature of the battery 304. One, some, or all steps of the example methods of FIGS. 7A and 7B may be performed by a video device (e.g., video device 301) and/or one or more components thereof. Accordingly, the example method of FIGS. 7A and 7B are described below using the example of performance by the video device 301. Also or alternatively, one, some, or all steps of the example methods of FIGS. 7A and 7B may be performed by one or more other computing devices (e.g., the mobile device 125, the video application server 122, etc.). Steps of the example methods of FIGS. 7A and 7B may be omitted, performed in other orders, and/or otherwise modified, and/or one or more additional steps may be added. The example methods of FIGS. 7A and 7B may be used in processes relating to cold batteries and/or operating in cold environments. The example methods of FIGS. 7A and 7B may each comprise examples, or together an example, of step 427 of FIG. 4C.

Referring to FIG. 7A, at step 701, the video device 301 and/or one or more components thereof may determine a link budget for a communications link associated with the video device 301. For example, video device 301 may determine a link budget for the communications link between the video device 301 and the gateway 111. An example link budget is described in more detail above with respect to step 406 of FIG. 4A.

At step 702, the video device 301 and/or one or more components thereof may determine a channel capacity of a communications channel associated with the video device 301. For example, the video device 301 may determine a channel capacity of a communications channel between the video device 301 and the gateway 111. Channel capacity is described above with respect to step 406 of FIG. 4A and step 502 of FIG. 5A. At step 703, the video device 301, and/or one or more components thereof, may determine the required data transfer rate for the present communications over the communications channel. For example, video device 301 may determine the required data transfer rate for communications over a wireless channel between the video device 301 and the gateway 111.

At step 704, the video device 301, and/or one or more components thereof, may be adjusted (e.g., altered, modified, etc.) to step increase the MCS level to decrease the amount of used FAT. Increasing the MCS level to decrease the amount of used FAT may improve the efficiency of one or more components of the video device 301. For example, with the higher MCS level, the radio 306 of the video device 310 may be on for a shorter period of time. MCS is additionally described above with respect to FIGS. 4A-4C. A step increase of the MCS level may comprise increasing the MCS level from that which was being used prior to step 704 but may be an MCS level other than (e.g., lower than) that which was used during normal video device 301 operation (e.g., at the start of the example method of FIGS. 4A-4C).

Other processes may be used in processes relating to cold batteries and/or operating in cold environments. Referring to FIG. 7B, at step 705, a video device 301 may determine the used resources at the processor 201. At step 706, the video device 301 may step decrease the processing load on its processor. Step decreasing the processing load on the processor may comprise step decreasing the overwork (e.g., artificial) load placed on the processor (e.g., at step 506 of FIG. 5B). For example, the video device 301 may terminate one or more of the processes (e.g., FOR loops) started at step 506 of FIG. 5B. Accordingly, the load on the processor may be reduced (e.g., the efficiency of the processor may be improved), and the processor may produce less heat. Thereby, less heat may be transferred to the battery 304 of the video device 301.

FIGS. 8A and 8B are flow charts showing steps of example methods associated with managing the temperature of a battery (e.g., battery 304). For example, one, some, or all steps of FIGS. 8A and/or 8B may be performed for a battery in a hot environment. Additionally, one, some, or all steps of FIGS. 8A and/or 8B may cause an increase in the temperature of the battery 304. One, some, or all steps of the example methods of FIGS. 8A and 8B may be performed by a video device (e.g., video device 301) and/or one or more components thereof. Accordingly, the example method of FIGS. 6A and 6B are described below using the example of performance by the video device 301. Also or alternatively, one, some, or all steps of the example methods of FIGS. 8A and 8B may be performed by one or more other computing devices (e.g., the mobile device 125, the video application server 122, etc.). Steps of the example methods of FIGS. 8A and 8B may be omitted, performed in other orders, and/or otherwise modified, and/or one or more additional steps may be added. The example methods of FIGS. 8A and 8B may be used in processes relating to hot batteries and/or video devices operating in hot environments. The example methods of FIGS. 8A and 8B may each comprise examples, or together, an example of step 427 of FIG. 4C.

Referring to FIG. 8A, at step 801, the video device 301 and/or one or more components thereof may determine a link budget for a communications link associated with the video device 301. For example, video device 301 may determine a link budget for the communications link between the video device 301 and the gateway 111. An example link budget is described in more detail above with respect to step 406 of FIG. 4A.

At step 802, the video device 301 and/or one or more components thereof may determine a channel capacity of a communication channel associated with the video device 301. For example, the video device 301 may determine a channel capacity of a communication channel between the video device 301 and the gateway 111. Channel capacity is described above, at least with respect to step 406 of FIG. 4A and step 502 of FIG. 5A. At step 803, the video device 301, and/or one or more components thereof, may determine the required data transfer rate for the present communications over the communications channel. For example, video device 301 may determine the required data transfer rate for communications over a wireless channel between the video device 301 and the gateway 111.

At step 804, the video device 301, and/or one or more components thereof, may be adjusted (e.g., altered, modified, etc.) to step decrease the MCS level to step increase the amount of used FAT. Decreasing the MCS level to increase the amount of used FAT may comprise a step adjustment toward normal (e.g., ideal) video device 301 operation. Additionally or alternatively, decreasing the MCS level may cause more heat production in the video device 301. For example, with lower MCS levels, the radio 306 of the video device 301 may be on for longer periods of time. MCS is additionally described above with respect to FIGS. 4A-4C. A step decrease of the MCS level may comprise decreasing the MCS level from that which was being used prior to step 804 but may be an MCS level other than that which was used (e.g., higher than) during normal video device 301 operation (e.g., at the start of the example method of FIGS. 4A-4C). Step 806 may relate to returning toward normal (e.g., ideal) video device 301 operation.

Other processes may be used in processes relating to hot batteries and/or operating in hot environments. Referring to FIG. 8B, at step 805, a video device 301 may determine the available resources at the processor 201. At step 806, the video device 301 may step increase the processing load on its processor. Step increasing the processing load on the processor of step 806 may comprise resuming one or more of the processes terminated, for example, in step 606 of FIG. 6B. For example, the video device 301 may resume one or more of the non-essential processes terminated at step 606 of FIG. 6B. Accordingly, the load on the processor may be increased toward normal (e.g., ideal) operation.

Although examples are described above with respect to video devices, the present disclosure is not so limited. Rather, examples of the present disclosure may be practiced with any device having a battery and a processor and/or a communications interface (e.g., a wireless communications interface).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only and is not limiting.

1. A method comprising:
receiving, by one or more processors of a video device, an indication of a temperature associated with a battery of the video device;
determining that the temperature associated with the battery of the video device satisfies a threshold; and
based on determining that the temperature of the battery satisfies the threshold, adjusting an operating efficiency of one or more wireless communications components of the video device.

2. The method of claim 1, wherein the adjusting the operating efficiency of the one or more wireless communications components of the video device comprises reducing the operating efficiency of the one or more wireless communications components of the video device.

3. The method of claim 1, wherein the adjusting the operating efficiency of the one or more wireless communications components of the video device comprises:
determining a link budget for wireless communications associated with the video device; and
adjusting the operating efficiency of the one or more wireless communications components based on the determined link budget.

4. The method of claim 1, wherein the adjusting the operating efficiency of the one or more wireless communications components comprises:
determining a channel capacity of a wireless communications channel associated with the video device; and
adjusting the operating efficiency of the one or more wireless communications components based on the determined channel capacity of the wireless communications channel associated with the video device.

5. The method of claim 1, wherein the adjusting the operating efficiency of the one or more wireless communications components comprises:
reducing a modulation and coding scheme (MCS) level used by the one or more wireless communications components of the video device.

6. The method of claim 1, wherein the determining that the temperature associated with the battery satisfies the threshold comprises determining that the temperature associated with the battery is below a predetermined range of operating temperatures.

7. The method of claim 1, wherein the adjusting the operating efficiency of the one or more wireless communications components comprises causing an increase to an on time of a transceiver associated with the video device.

8. The method of claim 1, wherein the one or more wireless communications components comprise one or more transceiver chips.

9. The method of claim 1, wherein the video device comprises a video doorbell device, the method further comprising:
disabling, based on the determining that the temperature of the battery satisfies the threshold, a doorbell chime associated with the video doorbell device.

10. The method of claim 1, wherein the adjusting the operating efficiency of the one or more wireless communications components of the video device comprises reducing the operating efficiency of the one or more wireless communications components of the video device, the method further comprising:
receiving an indication of a second temperature associated with the battery of the video device;
determining that the second temperature does not satisfy the threshold; and
based on determining that the second temperature of the battery does not satisfy the threshold, increasing the operating efficiency of the one or more wireless communications components of the video device.

11. The method of claim 1, wherein the determining that the temperature associated with the battery of the video device satisfies the threshold comprises determining that the temperature associated with the battery is below a predetermined range of operating temperatures, the method further comprising:
based on determining that the temperature associated with the battery is below the predetermined range, increasing a computational load on the one or more processors of the video device.

12. A method comprising:
receiving, by one or more processors of a video doorbell device, an indication of a temperature associated with a battery of the video doorbell device;
determining that the temperature associated with the battery of the video doorbell device is satisfies a threshold; and
based on determining that the temperature associated with the battery of the video doorbell device satisfies the threshold:
disabling a chime associated with the video doorbell device; and
reducing an operating efficiency of one or more of the following:
one or more wireless communications components associated with the video doorbell device; or
the one or more processors of the video doorbell device.

13. The method of claim 12, wherein the reducing the operating efficiency of the one or more wireless communications components of the video doorbell device comprises reducing a modulation and coding scheme (MCS) level used by the one or more wireless communications components of the video doorbell device.

14. The method of claim 12, wherein the reducing the operating efficiency of the one or more wireless communications components of the video doorbell device comprises causing an increase to an on time of a wireless transceiver of the video doorbell device.

15. The method of claim 12, wherein the reducing the operating efficiency of the one or more processors comprises increasing a computational load on the one or more processors.

16. A method comprising:
receiving, by one or more processors of a video device, an indication of a temperature associated with a battery of the video device;
determining that the temperature associated with the battery of the video device satisfies a threshold; and
based on determining that the temperature associated with the battery satisfies the threshold, adjusting an operating efficiency of the one or more processors of the video device.

17. The method of claim 16, wherein the adjusting the operating efficiency of the one or more processors comprises reducing the operating efficiency of the one or more processors of the video device.

18. The method of claim 16, wherein the adjusting the operating efficiency of the one or more processors comprises increasing a computational load on the one or more processors.

19. The method of claim 16, wherein the adjusting the operating efficiency of the one or more processors comprises causing the one or more processors to perform operations in excess of operations necessary for carrying out functions, of the video device, other than temperature control functions.

20. The method of claim 16, wherein the adjusting the operating efficiency of the one or more processors comprises reducing the operating efficiency of the one or more processors of the video device, the method further comprising:
receiving an indication of a second temperature associated with the battery of the video device; and
based on determining that the second temperature does not satisfy the threshold, increasing the reduced operating efficiency of the one or more processors of the video device.
